(19) United States
(12) Patent Application Publication
(10) Pub. No.: US 2020/0369795 A1
(43) Pub. Date: Nov. 26, 2020

(54) METHOD AND APPARATUS FOR PRODUCING CHELATE RESIN, AND METHOD FOR PURIFYING TO-BE-TREATED LIQUID

(71) Applicant: ORGANO CORPORATION, Tokyo (JP)

(72) Inventors: Yasuhiro YOSHIMURA, Tokyo (JP); Haruo YOKOTA, Tokyo (JP); Akira NAKAMURA, Tokyo (JP)

(73) Assignee: ORGANO CORPORATION, Tokyo (JP)

(21) Appl. No.: 16/969,827

(22) PCT Filed: Feb. 4, 2019
(86) PCT No.: PCT/JP2019/003864

§ 371 Date: Aug. 13, 2020

(30) Foreign Application Priority Data
Feb. 22, 2018 (JP) 2018-029575

(51) Int. Cl. C08F 8/40; B01J 45/00; C08F 212/14

(52) U.S. Cl. CPC C08F 8/40; C08F 212/14; B01J 45/00

(57) ABSTRACT

Provided is a method for producing a chelate resin, wherein a highly pure treatment liquid can be obtained by reducing the amount of metal impurities in a to-be-treated liquid containing metal impurities. The method for producing a chelate resin comprises a purification step for purifying a to-be-purified chelate resin by bringing the chelate resin into contact with at least 5 wt % of a mineral acid solution containing 1 mg/L or less of metal impurities, wherein the total amount of metal impurities eluted when 3 wt % of hydrochloric acid is passed through the purified chelate resin in an amount equal to 25 times the amount of the chelate resin by volume ratio is 5 μm/mL-R or less.

### CROSS REFERENCE TO RELATED APPLICATION

This application claims priority to Japanese Patent Application No. 2018-029575 filed on Feb. 22, 2018, which is incorporated herein by reference in its entirety including the specification, claims, drawings, and abstract.

### TECHNICAL FIELD

The present disclosure relates to a method and apparatus for producing a chelate resin, and a method for purifying a liquid to be treated using the chelate resin.

### BACKGROUND

In production processes for semiconductor integrated circuits (IC), flat panel displays (FPD) such as liquid crystal displays (LCD), electronic components such as imaging elements (CCD, CMOS), and various recording media such as CD-ROM and DVD-ROM (these products are jointly referred to as “electronic industry products”), various chemical liquids, dissolution solvents, electronic materials (such as liquid materials), raw materials and dissolution solvents for electronic materials, and washing water and the like are used (these liquids are jointly referred to as “production liquids”). In recent years, improvements in the performance and quality of electronic industry products have led to increased demands for higher purity forms of these production liquids and raw materials and dissolution solvents for electronic materials.

If these production liquids contain ionic impurities of metals (such as sodium (Na), calcium (Ca), magnesium (Mg) or iron (Fe)) (these impurities are jointly referred to as “metal impurity ions”), then these metal impurity ions may have a significant effect on the performance and quality and the like of the electronic industry products. Accordingly, the impurity content (and particularly the metal content) of these production liquids must be extremely low, namely the production liquids must have high purity. For example, in the case of pure water, a metal content of not more than about 1 ppt is required, and other chemical liquids also require metal content values in the order of ppt.

For example, Patent Document 1 discloses a method for reducing the amount of metal impurities by using a cation exchange resin that has been purified by contact with a specific mineral acid solution to purify a liquid to be treated such as a production liquid that contains metal impurities.

### CITATION LIST

### Patent Literature

Patent Document 1: JP 4441472 B

### SUMMARY

However, in cases such as the method of Patent Document 1, where a cation exchange resin is used in the purification of an ester or a ketone or the like, the cation exchange resin can sometimes cause reaction of the carbonyl moiety with nucleophiles such as water. Particularly in the case of esters, a hydrolysis reaction tends to proceed, producing an alcohol and an organic acid, with these compounds being incorporated as impurities in the purified treated liquid.

Objects of the present disclosure are to provide a method and an apparatus for producing a chelate resin that are capable of reducing the amount of metal impurities in a liquid to be treated containing metal impurities to obtain a high-purity treated liquid, and to provide a method for purifying a liquid to be treated using the chelate resin.

The present disclosure provides a method for producing a chelate resin that includes a purification step of purifying a chelate resin that is to be purified by bringing a mineral acid solution having a metal impurities content of not more than 1 mg/L and a concentration of at least 5% by weight into contact with the chelate resin, wherein the total amount of metal impurities eluted when hydrochloric acid having a concentration of 3% by weight is passed through the purified chelate resin in an amount equivalent to 25 times the volume of the chelate resin is not more than 5 μg/mL-R.

In the method for producing a chelate resin described above, the amounts of sodium (Na), calcium (Ca), magnesium (Mg) and iron (Fe) in the mineral acid solution used in the purification step may be each not more than 200 μg/L.

The method for producing a chelate resin described above may include, after the purification step, a washing step of washing the chelate resin that has been brought into contact with the mineral acid solution with pure water or ultrapure water.

In the method for producing a chelate resin described above, the chelate resin may have aminomethyl phosphate groups or iminodiacetate groups as chelating groups.

The present disclosure also provides an apparatus for producing a chelate resin that contains a purification unit for purifying a chelate resin that is to be purified by bringing a mineral acid solution having a metal impurities content of not more than 1 mg/L and a concentration of at least 5% by weight into contact with the chelate resin, wherein the total amount of metal impurities eluted when hydrochloric acid having a concentration of 3% by weight is passed through the purified chelate resin in an amount equivalent to 25 times the volume of the chelate resin is not more than 5 μg/mL-R.

In the apparatus for producing a chelate resin described above, the amounts of sodium (Na), calcium (Ca), magnesium (Mg) and iron (Fe) in the mineral acid solution used in the purification unit may be each not more than 200 μg/L.

The apparatus for producing a chelate resin described above may include a washing unit for washing the chelate resin that has been brought into contact with the mineral acid solution with pure water or ultrapure water.

In the apparatus for producing a chelate resin described above, the chelate resin may have aminomethyl phosphate groups or iminodiacetate groups as chelating groups.

The present disclosure also provides a method for purifying a liquid to be treated that uses a chelate resin obtained using the method for producing a chelate resin described above to purify a liquid to be treated containing metal impurities, thereby reducing the amount of metal impurities.

The present disclosure is able to provide a method and an apparatus for producing a chelate resin that are capable of reducing the amount of metal impurities in a liquid to be treated containing metal impurities to obtain a high-purity treated liquid, and can also provide a method for purifying a liquid to be treated using the chelate resin.

### BRIEF DESCRIPTION OF DRAWINGS

FIG. 1 is a schematic structural diagram illustrating one example of a production apparatus according to an embodiment of the present disclosure.

FIG. 2 is a cross-sectional diagram schematically illustrating the structure of a chelate resin column in a production apparatus according to an embodiment of the present disclosure, and is a diagram that describes the method used for subjecting the chelate resin to a purification treatment (metal impurities reduction treatment).

FIG. 3 is a diagram describing a method for subjecting a chelate resin to a washing treatment.

FIG. 4 is a schematic structural diagram illustrating one example of a purification apparatus according to an embodiment of the present disclosure.

FIG. 5 is a cross-sectional diagram schematically illustrating the structure of a chelate resin column in a purification apparatus according to an embodiment of the present disclosure, and is a diagram that describes a method for using the chelate resin to perform a purification treatment of a liquid to be treated.

### DESCRIPTION OF EMBODIMENTS

Embodiments of the present disclosure are described below. These embodiments are merely examples of implementing the present disclosure, and the present disclosure is in no way limited by these embodiments.

### <Method for Producing Chelate Resin>

A method for producing a chelate resin according to an embodiment of the present disclosure includes a purification step of purifying a chelate resin that is to be purified by bringing a mineral acid solution having a metal impurities content of not more than 1 mg/L and a concentration of at least 5% by weight into contact with the chelate resin, wherein the total amount of metal impurities eluted when hydrochloric acid having a concentration of 3% by weight is passed through the purified chelate resin in an amount equivalent to 25 times the volume of the chelate resin is not more than 5 μg/mL-R.

The inventors of the present disclosure investigated the purification of liquids to be treated such a production liquids containing metal impurities, and focused their attention on chelate resins rather than ion exchange resins such as cation exchange resins. In order to enable the use of chelate resins, the inventors investigated the purification of chelate resins by bringing the resins into contact with a mineral acid solution, but if the contacting mineral acid solution itself contains metal impurities, then not only is it difficult to reduce the amount of metal impurities within the chelate resin, but in some cases, the metal impurities in the mineral acid solution may adsorb to the chelate resin, resulting in an increase in the amount of metal impurities. In such cases, use of the chelate resin that has been brought into contact with the mineral acid solution actually elutes a large amount of metal impurities and the like into the liquid being treated. In particular, among the various metals, sodium (Na), calcium (Ca), magnesium (Mg) and iron (Fe) exist in chelate resins in large amounts compared with other metals, and reducing the amounts of these metals by contact with a mineral acid solution is difficult.

The inventors of the present disclosure discovered that by using a method for producing a chelate resin in which, by bringing a mineral acid solution having a metal impurities content of not more than 1 mg/L and a concentration of at least 5% by weight into contact with the chelate resin that is to be purified, the total amount of metal impurities eluted when hydrochloric acid having a concentration of 3% by weight was passed through the purified chelate resin in an amount equivalent to 25 times the volume of the chelate resin could be reduced to not more than 5 μg/mL-R, a chelate resin could be obtained which was capable of reducing the amount of metal impurities in a liquid to be treated containing metal impurities, yielding a high-purity treated liquid.

By bringing the chelate resin into contact with a mineral acid solution containing a small amount of metal impurities and having a high acid concentration, the amount of metal impurities in the chelate resin can be reduced reliably and effectively, and a chelate resin containing minimal eluted metal impurities can be obtained. Specifically, the total amount of metal impurities eluted when hydrochloric acid having a concentration of 3% by weight is passed through the chelate resin in an amount equivalent to 25 times the volume of the chelate resin (and in particular, the amount of eluted metals such as Na, Ca, Mg and Fe) can be reduced to not more than 5 μg/mL-R. By purifying a liquid to be treated such as a production liquid using this chelate resin, a high-purity treated liquid containing minimal metal impurities can be obtained. Further, in those cases where a cation exchange resin is used, water contained in the liquid to be treated or water incorporated in the cation exchange resin may sometimes react with protons derived from the cation exchange resin to produce acids such as acetic acid or the like, which then becomes mixed with the purified treated liquid as an impurity, but by using a chelate resin obtained using this production method, the amount of metal impurities can be reduced and a high-purity treated liquid can be obtained.

Chelate resins are resins having functional groups that can form a chelate (complex) with metal ions. There are no particular limitations on these functional groups, provided they can form chelates (complexes) with metal ions, and examples include aminomethyl phosphate groups, iminodiacetate groups, thiol groups and polyamine groups. From the viewpoint of factors such as achieving selectivity relative to a plurality of metals, the chelate resin may have aminomethyl phosphate groups or iminodiacetate groups as the chelate groups.

Examples of resins that may be used as the chelate resin include AmberSep IRC747 UPS (chelate groups: aminomethyl phosphate groups) and AmberSep IRC748 (chelate groups: iminodiacetate groups) (both product names, manufactured by The Dow Chemical Company). If necessary, the chelate resin may be subjected to a pretreatment such as a regeneration treatment prior to use.

The ionic form of AmberSep IRC747 UPS and AmberSep IRC748 is standardly the Na-form, but contact with the mineral acid solution in the above method changes the ionic form from the Na-form to the H-form.

The mineral acid solution used in the purification of the chelate resin is a solution of an inorganic acid. Examples of the mineral acid include hydrochloric acid, sulfuric acid, and nitric acid. Examples of the solvent used in forming the solution include pure water (resistivity: about 10 MΩ·cm) and ultrapure water (resistivity: about 18 MΩ·cm).

The amount of metal impurities in the mineral acid solution used in the purification step is not more than 1 mg/L. This amount may be as low as possible, and may be not more than 0.5 mg/L, and may be 0.2 mg/L or less. In those cases where the amount of metal impurities in the mineral acid solution exceeds 1 mg/L, a satisfactory reduction effect on the amount of metal impurities in the chelate resin becomes unattainable.

The concentration of mineral acid in the mineral acid solution is at least 5% by weight, and may be 10% by weight or higher. In those cases where the concentration of mineral acid in the mineral acid solution is less than 5% by weight, a satisfactory reduction effect on the amount of metal impurities in the chelate resin becomes unattainable. The upper limit for the concentration of mineral acid in the mineral acid solution is, for example, 37% by weight.

In this description, the term “metal impurities” is a generic term that includes metal ion impurities as well as metals, and representative examples include sodium (Na), calcium (Ca), magnesium (Mg) and iron (Fe).

The amounts of sodium (Na), calcium (Ca), magnesium (Mg) and iron (Fe) in the mineral acid solution used in the purification step may be each as low as possible, and may be each not more than 200 μg/L, and may be each 100 μg/L or less. By bringing a mineral acid solution in which these amounts of metal impurities are low into contact with the chelate resin, the amounts of metal impurities such as sodium (Na), calcium (Ca), magnesium (Mg) and iron (Fe) in the chelate resin can be reliably and effectively reduced.

The temperature of the mineral acid solution brought into contact with the chelate resin in the purification step is, for example, within a range from 0 to 30° C.

In the method for producing a chelate resin according to this embodiment, the purification step described above reduces the total amount of metal impurities eluted when hydrochloric acid having a concentration of 3% by weight is passed through the purified chelate resin in an amount equivalent to 25 times the volume of the chelate resin to a value of not more than 5 μg/mL-R, wherein this value may be as low as possible, and may be reduced to 1 μg/mL-R or less. By reducing this total amount of eluted metal impurities to not more than 5 μg/mL-R, the amount of metal impurities eluted from the chelate resin into the liquid being treated when the chelate resin is used for purifying a liquid to be treated can be reduced.

The eluted metal impurities may include at least one metal from among sodium (Na), calcium (Ca), magnesium (Mg) and iron (Fe).

The method may include, following the purification step, a washing step of washing the chelate resin that has been brought into contact with the mineral acid solution with a wash liquid such as ultrapure water. By washing the chelate resin with a wash liquid such as pure water or ultrapure water following the contact with the mineral acid solution, recontamination with metal impurities when removing the mineral acid solution from the purified chelate resin can be suppressed.

Examples of the wash liquid that is brought into contact with the chelate resin in the washing step include pure water and ultrapure water, and in terms of suppressing contamination following the purification, the wash liquid may be ultrapure water.

The temperature of the wash liquid brought into contact with the chelate resin in the washing step is, for example, within a range from 0 to 30° C.

Specific examples of the above method for producing a chelate resin are described below.

### <Method for Purifying Liquid to be Treated>

A method for purifying a liquid to be treated according to an embodiment of the present disclosure is a method that uses a chelate resin obtained using the method for producing a chelate resin described above to purify a liquid to be treated containing metal impurities, thereby reducing the amount of metal impurities.

The liquid to be treated that represents the target of the purification is a liquid that is to be purified by the chelate resin, and is, for example, a liquid such as a production liquid, with specific examples including chemical liquids, solvents such as dissolution solvents, electronic materials and the like (including not only electronic materials themselves, but also the raw materials and dissolution solvents used in electronic materials), and wash waters and the like used in the production of semiconductor integrated circuits (IC), flat panel displays (FPD) such as liquid crystal displays (LCD), electronic components such as imaging elements (CCD, CMOS), and various recording media such as CD-ROM and DVD-ROM (these products are jointly referred to as “electronic industry products”).

Examples of the chemical liquids include hydrogen peroxide, hydrochloric acid, hydrofluoric acid, phosphoric acid, acetic acid, tetramethylammonium hydroxide, and aqueous solutions of ammonium fluoride.

Examples of the solvents include organic solvents such as acetone, 2-butanone, n-butyl acetate, ethanol, methanol, 2-propanol, toluene, xylene, propylene glycol methyl ether acetate, N-methyl-2-pyrrolidone, ethyl lactate, phenol compounds, dimethyl sulfoxide, tetrahydrofuran, γ-butyrolactone, and polyethylene glycol monomethyl ether (PGMEA).

Examples of the electronic materials and the like include semiconductor-related materials (such as resists, release agents, antireflective films, interlayer insulating film coating materials, and coating materials for buffer coating films), and materials for flat panel displays (FPD) (such as photoresists for liquid crystals, materials for color filters, alignment films, sealing materials, liquid crystal mixtures, polarizing plates, reflective plates, overcoat agents and spacers).

Examples of the wash waters include the pure water and ultrapure water used for washing semiconductor substrates and liquid crystal substrates and the like.

Examples of the liquid to be treated include ester-based and ketone-based organic solvents, and particularly ester-based solvents, which are prone to hydrolysis upon contact with cation exchange resins. For example, when purifying polyethylene glycol monomethyl ether (PGMEA), a chelate resin purified using the above method for producing a chelate resin can be used favorably.

A specific example of the method for purifying a liquid to be treated using a chelate resin obtained using the above method for producing a chelate resin is described below.

### <Example of Method and Apparatus for Producing Chelate Resin>

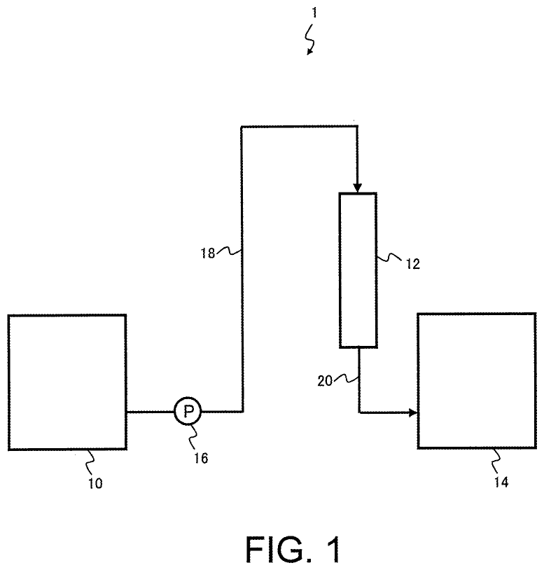

A production method (purification method) and a production apparatus (purification apparatus) for producing a chelate resin according to an embodiment of the present disclosure is described below using the drawings. FIG. 1 is a schematic structural diagram illustrating the overall structure of this production apparatus 1.

The production apparatus 1 of FIG. 1 includes a chelate resin column 12 as a purification unit for bringing a mineral acid solution having a metal impurities content of not more than 1 mg/L and a concentration of at least 5% by weight into contact with a chelate resin that is to be purified, thereby purifying the chelate resin. The production apparatus 1 may also include a raw liquid tank 10 for storing the mineral acid solution or the like, and a discharged liquid tank 14 for storing the discharged liquid and the like.

In the production apparatus 1, the outlet of the raw liquid tank 10 and the supply port of the chelate resin column 12 are connected by a line 18 via a pump 16, and the discharge port of the chelate resin column 12 and the inlet of the discharged liquid tank 14 are connected via a line 20.

A mineral acid solution is stored inside the stock raw liquid 10. This mineral acid solution has a metal impurities content of not more than 1 mg/L and a concentration of at least 5% by weight.

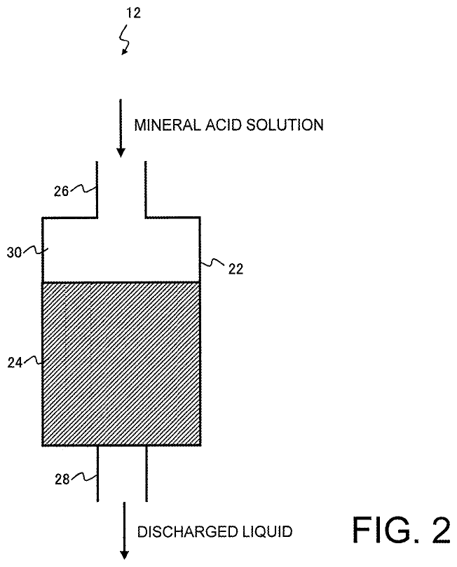

FIG. 2 is a cross-sectional diagram schematically illustrating the structure of the chelate resin column 12. The chelate resin column 12 is constructed having a storage member 22 and a chelate resin 24. The storage member 22 is constructed, for example, from a resin material such as a fluororesin, and has a supply port 26 for supplying the mineral acid solution and a discharge port 28 for discharging liquid externally. A storage chamber 30 is positioned in the pathway between the supply port 26 and the discharge port 28, and the chelate resin 24 is housed inside the storage chamber 30. In other words, the mineral acid solution supplied from the supply port 26 passes through the chelate resin 24 and is discharged externally from the discharge port 28, and as a result, the chelate resin 24 undergoes purification.

When the pump 16 is activated in the production apparatus 1, the mineral acid solution inside the raw liquid tank 10 passes through the line 18 and is supplied toward the supply port 26 of the chelate resin column 12. A plurality of pumps 16 may be provided in the line depending on the flow rate of mineral acid solution required for the purification.

The mineral acid solution is supplied from the supply port 26, and by passing (flowing) the mineral acid solution through the chelate resin 24 and then discharging the mineral acid solution from the discharge port 28, the chelate resin 24 requiring purification is purified by contact with the mineral acid solution (the purification step). The discharge liquid discharged from the discharge port 28 passes through the line 20 and is stored in the discharged liquid tank 14 as required.

As a result of this purification treatment (metal impurities content reduction treatment), the total amount of metal impurities eluted when hydrochloric acid having a concentration of 3% by weight is passed through the purified chelate resin in an amount equivalent to 25 times the volume of the chelate resin is not more than 5 μg/mL-R. Accordingly, a high-quality chelate resin having a low metal impurities content can be obtained.

In this embodiment, the purification treatment (metal impurities content reduction treatment) is conducted using the chelate resin 24 housed inside the storage chamber 30 of the storage member 22 of the chelate resin column 12 used in the production apparatus 1, but the purification may of course also be conducted by housing the chelate resin 24 in a special storage member designed for the metal impurities content reduction treatment and provided separately from the storage member 22. Further, in this embodiment the contact between the chelate resin 24 and the mineral acid solution is achieved by passing the mineral acid solution through the chelate resin 24, but the purification treatment may of course also be conducted by dipping the chelate resin 24 in a reservoir of the mineral acid solution.

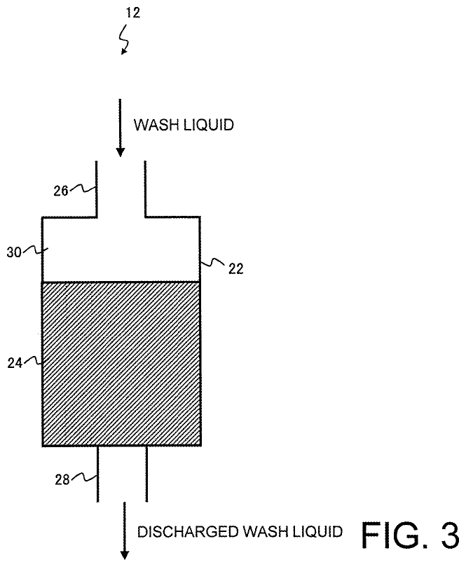

Following passage of the mineral acid solution to reduce the metal impurities content, the chelate resin 24 is washed with ultrapure water. For example, a wash liquid such as pure water or ultrapure water is stored in the raw liquid tank 10 or a separately provided tank, and by activating the pump 16, the wash liquid inside the raw liquid tank 10 passes through the line 18 and is supplied toward the supply port 26 of the chelate resin column 12. As illustrated in FIG. 3, the wash liquid is supplied from the supply port 26, and by passing (flowing) the wash liquid through the chelate resin 24 and then discharging the wash liquid from the discharge port 28, the chelate resin 24 that is to be washed is washed by contact with the wash liquid (the washing step). In the washing step, the chelate resin column 12 functions as the washing unit. The discharged wash liquid discharged from the discharge port 28 passes through the line 20 and is stored in the discharged liquid tank 14 as required.

By performing this washing treatment, a high-quality chelate resin having an extremely low metal impurities content can be obtained.

In this embodiment, the washing treatment is conducted with the chelate resin 24 housed inside the storage chamber 30 of the storage member 22 of the chelate resin column 12 used in the production apparatus 1, but the washing treatment may of course also be conducted by housing the chelate resin 24 in a special storage member designed for the washing treatment and provided separately from the storage member 22. Further, in this embodiment, the contact between the chelate resin 24 and the wash liquid is achieved by passing the wash liquid through the chelate resin 24, but the washing may of course also be conducted by dipping the chelate resin 24 in a reservoir of the wash liquid.

The liquid contact portions within the production apparatus 1 that make contact with the mineral acid solution (for example, the internal passages inside the pump 16, the internal walls of the lines 18 and 20, liquid contact portions of the storage member 22 such as the internal walls, and the insides of the raw liquid tank 10 and the discharged liquid tank 14) may be formed from, or coated with, a material that is inert relative to the mineral acid solution. This ensures that the liquid contact portions are inert relative to the mineral acid solution, and can reduce effects such as the elution of metal impurities from the liquid portions into the chelate resin.

Examples of materials that are inert relative to the mineral acid solution and can be used for the liquid contact portions include fluororesins, polypropylene resins and polyethylene resins, and in terms of metal elution and the like, the materials may be fluororesins. Examples of fluororesins include PTFE (tetrafluoroethylene resins), PFA (tetrafluoroethylene-perfluoroalkoxyethylene copolymer resins), ETFE (tetrafluoroethylene-ethylene copolymer resins), FEP (tetrafluoroethylene-hexafluoropropylene copolymer resins), PVDF (vinylidene fluoride resins), ECTFE, (ethylene-chlorotrifluoroethylene resins), PCTFEP (chlorotrifluoroethylene resins), and PVF (vinyl fluoride resins).

### <Example of Method and Apparatus for Purifying Liquid to be Treated>

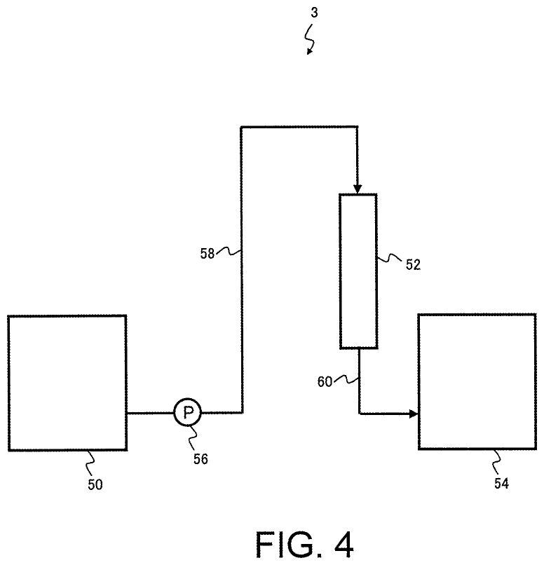

A purification method and a purification apparatus for purifying a liquid to be treated according to an embodiment of the present disclosure is described below using the drawings. FIG. 4 is a schematic structural diagram illustrating the overall structure of this purification apparatus 3.

The purification apparatus 3 of FIG. 4 includes a chelate resin column 52 as a liquid to be treated purification unit that is used for bringing a liquid to be treated that represents the purification target into contact with a chelate resin, thereby purifying the liquid to be treated. The purification apparatus 3 may also include a raw liquid tank 50 for storing the liquid to be treated, and a discharged liquid tank 54 for storing the treated liquid.

In the purification apparatus 3, the outlet of the raw liquid tank 50 and the supply port of the chelate resin column 52 are connected by a line 58 via a pump 56, and the discharge port of the chelate resin column 52 and the inlet of the discharged liquid tank 54 are connected via a line 60.

The liquid to be treated that represents the purification target is stored in the raw liquid tank 50.

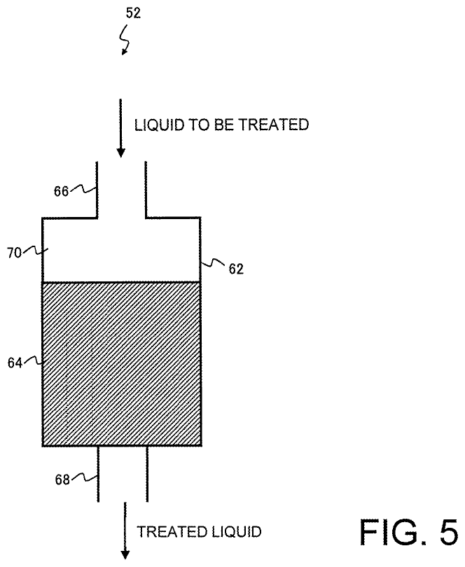

FIG. 5 is a cross-sectional diagram schematically illustrating the structure of the chelate resin column 52. The chelate resin column 52 is constructed having a storage member 62 and a chelate resin 64. The storage member 62 is constructed, for example, from a resin material such as a fluororesin, and has a supply port 66 for supplying the liquid to be treated and a discharge port 68 for discharging liquid externally. A storage chamber 70 is positioned in the pathway between the supply port 66 and the discharge port 68, and the chelate resin 64 is housed inside the storage chamber 70. In other words, the liquid to be treated supplied from the supply port 66 passes through the chelate resin 64 and is discharged externally from the discharge port 68, and as a result, the liquid to be treated undergoes purification. This chelate resin 64 is obtained using the chelate resin production method and production apparatus described above, is a chelate resin for which the total amount of metal impurities eluted when hydrochloric acid having a concentration of 3% by weight is passed through the resin in an amount equivalent to 25 times the volume of the chelate resin is not more than 5 μg/mL-R, and is a chelate resin which has already undergone a treatment to reduce the amount of metal impurities in the resin, and therefore has an extremely low metal impurities content.

When the pump 56 is activated in the purification apparatus 3, the liquid to be treated inside the raw liquid tank 50 passes through the line 58 and is supplied toward the supply port 66 of the chelate resin column 52. A plurality of pumps 56 may be provided in the line depending on the flow rate of the liquid to be treated required for the purification.

The liquid to be treated is supplied from the supply port 66, and by passing (flowing) the liquid to be treated through the chelate resin 64 and then discharging the liquid from the discharge port 68, the liquid to be treated requiring purification is purified by contact with the chelate resin 64 (the liquid to be treated purification step). The treated liquid discharged from the discharge port 68 passes through the line 60 and is stored in the discharged liquid tank 54 as required.

As a result of this purification treatment (metal impurities content reduction treatment), the amount of metal impurities in the treated liquid (for example, where the amount of each metal impurity is not more than 1,000 μg/L) is reduced to 10 μg/L or less. Accordingly, a high-quality treated liquid having a low metal impurities content can be obtained.

By constructing a chelate resin column using a chelate resin for which the amount of metal impurities in the resin has been reduced by contact with a mineral acid solution having an extremely low metal impurities content, a purification treatment (metal impurities content reduction treatment) of a liquid to be treated using this chelate resin column is able to reduce the elution of metal impurities into the treated liquid. Accordingly, a high-quality treated liquid having a low metal impurities content can be obtained.

In this embodiment, the purification treatment (metal impurities content reduction treatment) is conducted using the chelate resin 64 housed inside the storage chamber 70 of the storage member 62 of the chelate resin column 52 used in the purification apparatus 3, but the purification treatment may of course also be conducted by housing the chelate resin 64 in a special storage member designed for the metal impurities content reduction treatment and provided separately from the storage member 62. Further, in this embodiment the contact between the chelate resin 64 and the liquid to be treated is achieved by passing the liquid to be treated through the chelate resin 64, but the purification treatment may of course also be conducted by dipping the chelate resin 64 in a reservoir of the liquid to be treated.

In those cases where the liquid to be treated that represents the purification target is a liquid such as an organic solution or a non-polar solution for which contamination with small amounts of moisture is undesirable, the water content of the chelate resin 64 may be reduced in advance, using a drying treatment such as vacuum drying, shelf drying or hot-air drying, to a value of, for example, not more than 30% by weight, and or 10% by weight or less. This can suppress elution of the moisture into the treated liquid.

Using the chelate resin 64 having a reduced moisture content in this manner is particularly effective in those cases where contamination of the treated liquid with small amounts of moisture is a problem. Of course, even in those cases where such contamination is not a problem, using the chelate resin 64 having a reduced moisture content means that moisture in the chelate resin 64 need not be substituted with an intermediate polarity solvent (such as an alcohol) prior to purification of the liquid to be treated, which is desirable.

The liquid contact portions within the purification apparatus 3 that make contact with the liquid to be treated (for example, the internal passages inside the pump 56, the internal walls of the lines 58 and 60, liquid contact portions of the storage member 62 such as the internal walls, and the insides of the raw liquid tank 50 and the discharged liquid tank 54) may be formed from, or coated with, a material that is inert relative to the liquid to be treated. This ensures that the liquid contact portions are inert relative to the liquid to be treated, and can reduce effects such as the elution of metal impurities from the liquid portions into the liquid being treated.

Examples of materials that are inert relative to the liquid to be treated and can be used for the liquid contact portions include fluororesins, polypropylene resins and polyethylene resins, and in terms of metal elution and the like, the materials may be fluororesins. Examples of fluororesins include PTFE (tetrafluoroethylene resins), PFA (tetrafluoroethylene-perfluoroalkoxyethylene copolymer resins), ETFE (tetrafluoroethylene-ethylene copolymer resins), FEP (tetrafluoroethylene-hexafluoropropylene copolymer resins), PVDF (vinylidene fluoride resins), ECTFE (ethylene-chlorotrifluoroethylene resins), PCTFEP (chlorotrifluoroethylene resins), and PVF (vinyl fluoride resins).

If the purification apparatus 3 also includes, at a stage subsequent to the chelate resin column 52, a filtration unit such as a filter for removing microparticulate impurities contained in the treated liquid, then not only eluted metal impurities, but also microparticulate impurities, can be reduced in the treated liquid, meaning an even higher purity treated liquid can be obtained.

### EXAMPLES

The present disclosure is described below in further detail using examples and a comparative example, but the present disclosure is not limited to the following examples.

### Example 1

Using a hydrochloric acid solution with an acid concentration of 10% by weight, purification treatments (metal impurities content reduction treatments) of the chelate resins AmberSep IRC747 UPS (chelate groups: aminomethyl phosphate groups) and AmberSep IRC748 (chelate groups: iminodiacetate groups) were conducted. The purification treatment conditions are shown in Table 1, and the amounts of metal impurities in the hydrochloric acid solution having an acid concentration of 10% by weight are shown in Table 2.

TABLE 1
Purification treatment conditions

| Chelate resin name | AmberSep IRC747 UPS | AmberSep IRC748 |
|---|---|---|
| Resin volume | 1,500 mL | 4,000 mL |
| Storage member for | Circular cylindrical | Circular cylindrical |
| chelate resin column | acrylic resin column | acrylic resin column |
| | (inner diameter: 47 mm, | (inner diameter: 78 mm, |
| | height 1000 mm) | height 1000 mm) |
| Amount of | 6,000 mL | 16,000 mL |
| hydrochloric | | |
| acid used | | |
| Treatment flow rate | SV4 | SV4 |
| Washing following | Washing with | Washing with |
| treatment | ultrapure water | ultrapure water |
| Amount of washing | 24 hours at SV8 | 24 hours at SV8 |

TABLE 2
Amounts of metal impurities in hydrochloric acid solution having
acid concentration of 10% by weight [μg/L]

| Metal | Amount |
|---|---|
| Li | <0.1 |
| Na | 1.0 |
| Mg | 0.8 |
| Al | 2.0 |
| K | 0.8 |
| Ca | 15.3 |
| Cr | <0.1 |
| Mn | <0.1 |
| Fe | 0.9 |
| Co | <0.1 |
| Ni | <0.1 |
| Cu | <0.1 |
| Zn | 0.5 |
| Cd | <0.1 |
| Pb | <0.1 |
| Total | 21 |

The amounts of metal impurities measured in these chelate resins following the purification treatment are shown in Table 3. The measurement conditions for measuring the amounts of metal impurities are shown in Table 4. For the ICP-MS (inductively coupled plasma mass spectrometer), a model 8900 manufactured by Agilent Technologies, Inc. was used.

TABLE 3
Measurement results for amounts of metal impurities
in chelate resins [μg/mL-R]

Amount of metal eluted

| Chelate resin name | IRC747 UPS H-form | IRC748 H-form |
|---|---|---|
| Li | 0.02 | <0.01 |
| Na | 0.05 | 0.03 |
| Mg | 0.02 | 0.02 |
| Al | <0.01 | <0.01 |
| K | <0.01 | <0.01 |
| Ca | 0.47 | 0.53 |
| Cr | <0.01 | <0.01 |
| Mn | <0.01 | <0.01 |
| Fe | <0.01 | 0.19 |
| Co | <0.01 | <0.01 |
| Ni | <0.01 | 0.01 |
| Cu | <0.01 | <0.01 |
| Zn | 0.09 | 0.02 |
| Cd | <0.01 | <0.01 |
| Pb | <0.01 | <0.01 |
| Total | 0.65 | 0.79 |

TABLE 4
Measurement conditions for amounts of metal impurities

Chelate resin name

| | |
|---|---|
| AmberSep IRC747 | AmberSep IRC748 |
| UPS H-form | H-form |

| | |
|---|---|
| Resin volume | 20 mL |
| Storage member | Circular cylindrical PFA resin |
| for chelate | (inner diameter: 16 mm, |
| resin column | height: 300 mm) |
| Hydrochloric | Concentration: 3% by weight |
| acid eluent | (ultrapure hydrochloric acid |
| | from KantoChemical Co., Inc. |
| | diluted with ultrapure water) |
| Treatment rate | SV4 |
| Hydrochloric | 500 mL |
| acid volume | |
| Measurement | Eluates in hydrochloric acid |
| method | analyzed using ICP-MS (inductively |
| | coupled plasma mass spectrometer) |

### Example 2

Using the chelate resins that had undergone the purification treatment in Example 1, purification treatments were conducted using a polyethylene glycol monomethyl ether (PGMEA) containing metal impurities as the liquid to be treated. The values for the amounts of metal impurities in the PGMEA before and after the purification treatment in the case of purification using the H-form of AmberSep IRC747 UPS are shown in Table 5, the values for the amounts of metal impurities in the PGMEA before and after the purification treatment in the case of purification using the H-form of AmberSep IRC748 are shown in Table 6, and the measurement conditions for measuring the amounts of metal impurities are shown in Table 7.

TABLE 5
Amounts of metal impurities in PGMEA purified
using H-form of IRC747UPS [ng/L]

| | | After purification |
|---|---|---|
| | | (after passage through |
| | Before purification | reduction-treated |
| Metal | (raw liquid) | chelate resin) |
| Na | 413.3 | <10 |
| Mg | 67.4 | <10 |
| Al | 48.4 | <10 |
| Ca | 137.0 | <10 |
| Ti | 21.6 | <10 |
| V | 41.6 | <10 |
| Cr | 32.9 | <10 |
| Mn | 56.9 | <10 |
| Fe | 60.6 | <10 |
| Ni | 78.3 | <10 |
| Cu | 84.4 | <10 |
| Zn | <10 | <10 |
| Ag | 10.3 | <10 |
| Cd | 72.6 | <10 |
| Ba | 26.1 | <10 |
| Pb | 53.7 | <10 |

TABLE 6
Amounts of metal impurities in PGMEA
purified using H-form of IRC748 [ng/L]

| | | After purification |
|---|---|---|
| | | (after passage through |
| | Before purification | reduction-treated |
| Metal | (raw liquid) | chelate resin) |
| Na | 131.5 | <10 |
| Mg | 47.3 | <10 |
| Al | 19.5 | <10 |
| Ca | 47.6 | <10 |
| Ti | <10 | <10 |
| V | 26.4 | <10 |
| Cr | 30.7 | <10 |
| Mn | 42.6 | <10 |
| Fe | 61.7 | <10 |
| Ni | 62.7 | <10 |
| Cu | 72.5 | <10 |
| Zn | 57.7 | <10 |
| Ag | <10 | <10 |
| Cd | 65.3 | <10 |
| Ba | 13.0 | <10 |
| Pb | 36.0 | <10 |

TABLE 7
Measurement conditions for amounts of metal impurities

| | |
|---|---|
| Measured resin volume | 36 mL |
| Storage member for chelate | Circular cylindrical PFA resin |
| resin column | (inner diameter: 16 mm, height: 300 mm) |
| Treatment rate | SV5 |
| Measurement method | Analysis by ICP-MS (inductively coupled |
| | plasma mass spectrometer) |
| Flow volume | 720 mL |

When purification was performed using a chelate resin that had been subjected to a purification treatment, the amount of each metal in the PGMEA was reduced to 10 ppt or less.

### Comparative Example 1

A purification treatment of PGMEA was conducted using a cation exchange resin (Amberlite 200 CT H) that had undergone the same purification treatment (metal impurities content reduction treatment) as Example 1.

Results comparing the change in the amount of acetic acid production when PGMEA was purified using the cation exchange resin purified in this manner and the amount of acetic acid production when PGMEA was purified using the chelate resins purified in Example 1 are shown in Table 8. The amount of acetic acid was measured using an ion chromatography apparatus (DX-600, manufactured by Thermo Fisher Scientific Inc.).

TABLE 8
Change in amount of acetic acid production [mg/L]

| | | After purification |
|---|---|---|
| | | (after passage through |
| | Before purification | reduction-treated |
| Resin used | (raw liquid) | chelate resin) |
| IRC 747UPS | 20 | 22 |
| IRC748 | 23 | 24 |
| 200CT H | 20 | 121 |

When PGMEA was purified using the purified cation exchange resin, the amount of acetic acid after the purification increased compared with the amount prior to purification. In contrast, when PGMEA was purified using the chelate resins purified in Example 1, substantially no change was observed in the value for the amount of acetic acid before purification and the amount after purification. It is thought that this is because moisture in the PGMEA or moisture in the resin reacts with protons derived from the cation exchange resin, or the PGMEA undergoes decomposition as a result of contact with the cation exchange resin, thus producing acetic acid.

Based on the above examples, it was evident that by conducting a purification treatment (metal impurities content reduction treatment) using a hydrochloric acid solution having a low metal impurities content, the amount of metal impurities in a chelate resin could be effectively reduced, and a purification using that chelate resin was able to effectively reduce the amount of metal impurities in a liquid to be treated. Further, even in the case of organic solvents that undergo a change in liquid properties when treated with a cation exchange resin, by using a chelate resin used in the method of the present disclosure, the amount of metal impurities could be reduced with almost no change in the liquid properties.

In this manner, a chelate resin was able to be obtained that was capable of reducing the metal impurities content of a liquid to be treated containing metal impurities, enabling a high-purity treated liquid to be obtained.

### REFERENCE SIGNS LIST

1: Production apparatus
3: Purification apparatus
10, 50: Raw liquid tank
12, 52: Chelate resin column
14, 54: Discharged liquid tank
16, 56: Pump
18, 20, 58, 60: Line
22, 62: Storage member
24, 64: Chelate resin
26, 66: Supply port
28, 68: Discharge port
30, 70: Storage chamber

1. A method for producing a chelate resin, comprising purifying a chelate resin that is to be purified by bringing a mineral acid solution having a metal impurities content of not more than 1 mg/L and a concentration of at least 5% by weight into contact with the chelate resin, wherein
a total amount of metal impurities eluted when hydrochloric acid having a concentration of 3% by weight is passed through the purified chelate resin in an amount equivalent to 25 times a volume of the chelate resin is not more than 5 μg/mL-R.

2. The method for producing a chelate resin according to claim 1, wherein
amounts of sodium (Na), calcium (Ca), magnesium (Mg) and iron (Fe) in the mineral acid solution used during the purifying are each not more than 200 μg/L.

3. The method for producing a chelate resin according to claim 1,
further comprising, after the purifying, washing the chelate resin that has been brought into contact with the mineral acid solution with pure water or ultrapure water.

4. The method for producing a chelate resin according to claim 1, wherein
the chelate resin has aminomethyl phosphate groups or iminodiacetate groups as chelating groups.

5. An apparatus for producing a chelate resin, comprising a purification unit for purifying a chelate resin that is to be purified by bringing a mineral acid solution having a metal impurities content of not more than 1 mg/L and a concentration of at least 5% by weight into contact with the chelate resin, wherein
a total amount of metal impurities eluted when hydrochloric acid having a concentration of 3% by weight is passed through the purified chelate resin in an amount equivalent to 25 times the volume of the chelate resin is not more than 5 μg/mL-R.

6. The apparatus for producing a chelate resin according to claim 5, wherein
amounts of sodium (Na), calcium (Ca), magnesium (Mg) and iron (Fe) in the mineral acid solution used in the purification unit are each not more than 200 μg/L.

7. The apparatus for producing a chelate resin according to claim 5,
further comprising a washing unit for washing the chelate resin that has been brought into contact with the mineral acid solution with pure water or ultrapure water.

8. The apparatus for producing a chelate resin according to claim 5, wherein
the chelate resin has aminomethyl phosphate groups or iminodiacetate groups as chelating groups.

9. A method for purifying a liquid to be treated which uses a chelate resin obtained using the method for producing a chelate resin according to claim 1 to purify a liquid to be treated containing metal impurities, thereby reducing an amount of metal impurities.
